(19) United States
(12) Patent Application Publication
(10) Pub. No.: US 2015/0058868 A1
(43) Pub. Date: Feb. 26, 2015

(54) TECHNIQUES FOR A COMMON OBJECT MODEL

(71) Applicants: Ramanathan Padinjarel, Sunnyvale, CA (US); Santosh Lolayekar, Sunnyvale, CA (US)

(72) Inventors: Ramanathan Padinjarel, Sunnyvale, CA (US); Santosh Lolayekar, Sunnyvale, CA (US)

(21) Appl. No.: 13/974,546

(22) Filed: Aug. 23, 2013

(51) Int. Cl. G06F 9/46

(52) U.S. Cl. CPC G06F 9/465
USPC 719/316

(57) ABSTRACT

Techniques for a common object model are described. In one embodiment, for example, an apparatus may comprise a common controller object and a first plugin. The common controller object may be operative to receive a standardized command from a module and to generate a first standardized plugin command based on the standardized command, the standardized command and first standardized plugin command conforming to a common object model. The plugin may be operative to execute the first standardized plugin command. Other embodiments are described and claimed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for a common object model. Some embodiments are particularly directed to techniques for a common object model providing a common application programming interface (API) for access to a backend system. In one embodiment, for example, an apparatus may comprise a common controller object and a first plugin. The common controller object may be operative to receive a standardized command from a module and to generate a first standardized plugin command based on the standardized command, the standardized command and first standardized plugin command conforming to a common object model. The plugin may be operative to execute the first standardized plugin command. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system for a common object model.

FIG. 2 illustrates a second block diagram of the system of FIG. 1.

FIG. 3 illustrates a third block diagram of the system of FIG. 1.

FIG. 4 illustrates a fourth block diagram of the system of FIG. 1.

FIG. 5 illustrates a fifth block diagram of the system of FIG. 1.

FIG. 6 illustrates a sixth block diagram of the system of FIG. 1.

FIG. 7 illustrates an embodiment of a logic flow for the system of FIG. 1.

FIG. 8 illustrates an embodiment of a centralized system for the system of FIG. 1.

FIG. 9 illustrates an embodiment of a distributed system for the system of FIG. 1.

FIG. 10 illustrates an embodiment of a computing architecture.

FIG. 11 illustrates an embodiment of a communications architecture.

### DETAILED DESCRIPTION

Various embodiments are directed to techniques for a common object model providing a common application programming interface (API) for access to a backend system. Backend systems, whether they are separate processes running a shared system, a backend server, or a plurality of backend servers, provide utility to other applications or software modules. These backend systems may be highly complex and provide a wide variety of functionality. For example, a backend system may provide distributed computing services and/or distributed storage services and may provide discovery, health monitoring, capacity management, provisioning, cloning, backing-up, restoration, and disaster recovery for these services.

Because of the complexity of backend systems, access to their functionality may be provided by a plurality of plugins. Confining a particular type of access—for example, provisioning—to a particular plugin may make the development process easier. An individual or team may be able to focus on the development of, for instance, a provisioning plugin while other individuals or teams focus on the development of a health-monitoring plugin, a file-reading plugin, etc. By allowing an individual or team to focus on a particular area of access higher-quality software may be produced than if a larger team had to cooperate for the creation of an entire API layer.

However, external applications, software modules, and other users of the backend system may benefit from a common API for access to the backend system. Various plugins used for accessing the backend system may use different object models for the representation of data, submission of commands, and return of results. As such, developers of external applications and software modules may benefit from a common object model for the representation of data, submission of commands, and return of results.

As such, an execution system may use a common object model to provide a common API layer for use of the backend system, where the common object model makes use of individual plugins for the actual work of interacting with the backend system. A software module may consume a common controller object of the common object model and use the common controller object for access to the backend system, with the common controller object identifying, for the various commands it receives, the appropriate plugin or plugins for executing the commands. The common controller object may then access the plugin or plugins using a common plugin API standardized across all plugins supported by the common object model, with the common plugin API using the same data representations and paradigm for submission of commands and return of results as the common API layer.

However, because the plugins may be developed by different individuals, different teams, or even different corporate entities, they may not internally use the common plugin API and may not internally fit the common object model. In some instances, new plugins developed after the creation of the common plugin API may conform to the common object model for the sake of convenience. However, a legacy plugin may, instead of being rewritten to conform to the common object model, be used in combination with a translation layer acting as a wrapper around the legacy plugin. The translation layer may translate between the common object model and the object model of the legacy plugin. By having the translation be performed by a plugin-specific translation layer the common object layer may be kept free of plugin-specific object models, simplifying development of the common object layer. In some cases, the translation layer may be created by the same individual or team that developed the legacy plugin, making use of their familiarity with the legacy plugin's object model. It will be appreciated that, in some cases, plugins developed after the creation of the common object model may still use their own plugin-specific internal object model and use a translation layer to interface with the common controller object.

The common object layer may provide a further benefit that it may provide commands as part of the common API that use multiple plugins. For example, a common API read-and-write command may be implemented by the common controller object making a read call to a read-specific plugin and a write call to a write-specific plugin, the read call and write call both conforming to the common plugin API. It will be appreciated that even more complex interactions may be created in which the common controller object demultiplexes a single received command into a plurality of commands, performs those commands using a corresponding plurality of plugins, and multiplexes the results of those commands into a single result. In some cases, one or more results of various commands executed with plugins may provide one or more inputs to other plugins.

As such, developers of external applications—which may be first or third party—may receive the benefit of a common API layer providing unified access to a backend system with a common object model while the internal developers of the execution system receive the benefit of being able to silo their work into discrete units contained within plugins, which may or may not conform to the common object model. As a result, the embodiments can improve affordability, scalability, modularity, extendibility, and interoperability for a backend system and its API.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

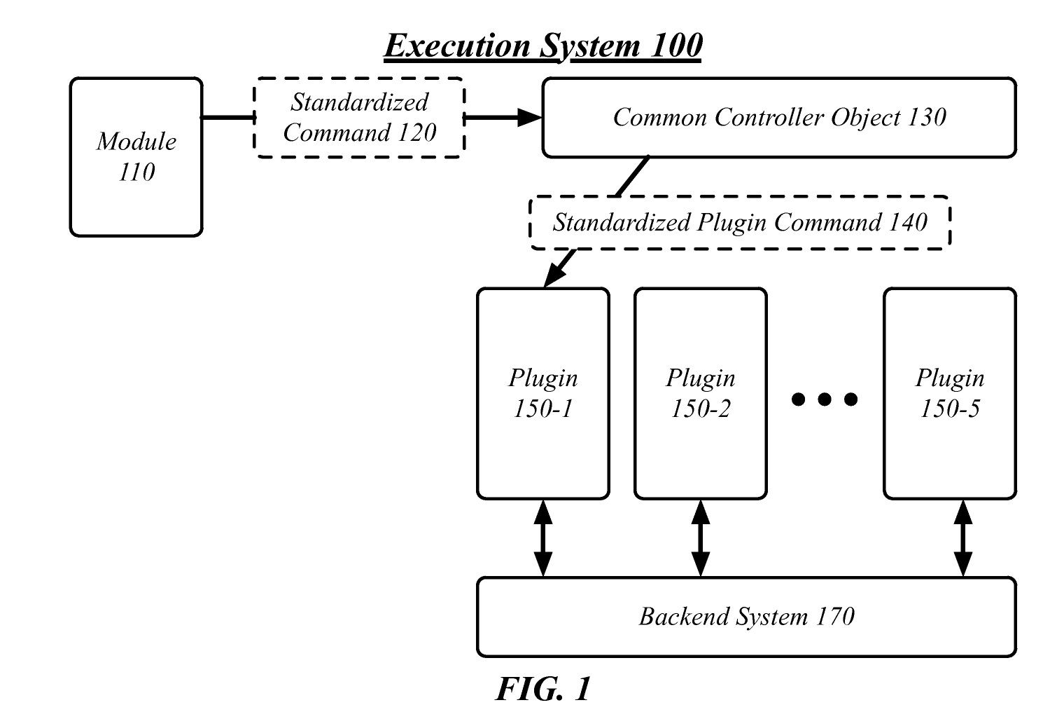

FIG. 1 illustrates a block diagram for a execution system 100. In one embodiment, the execution system 100 may comprise a computer-implemented execution system 100 comprising one or more components. Although the execution system 100 shown in FIG. 1 has a limited number of elements in a certain topology, it may be appreciated that the execution system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of plugins 150-a may include components 150-1, 150-2, 150-3, 150-4 and 150-5. The embodiments are not limited in this context.

The execution system 100 may comprise a common controller object 130. The common controller object 130 may be operative to receive a standardized command 120 from a module 110 and to generate a first standardized plugin command 140 based on the standardized command 120, the standardized command 120 and first standardized plugin command 140 conforming to a common object model. The standardized command 120 may comprise a request to access a backend system 170 by the module 110.

The execution system 100 may comprise a plurality of plugins 150-a. While in the illustrated embodiment of FIG. 1 depicts five plugins 150-1, 150-2, 150-3, 150-4, and 150-5, it will be appreciated that any number of plugins may be used. The plugins 150-a may provide access to a backend system 170 and perform various tasks using the backend system 170. The plugins 150-a, such as plugin 150-1, may receive a standardized plugin command 140 and execute the standardized plugin command 140 using the backend system 170.

The common controller object 130 may be operative to identify a plugin 150-1 of the plurality of plugins 150-a for the execution of the standardized command 120. In some embodiments, each command of a common layer API may have associated with it in the common controller object 130 one or more plugins for the execution of the command with associated logic for the submission of commands to the one or more plugins and processing of the results.

In some embodiments, plugins 150-a may conform to predefined roles—reading data, writing data, determining the health of the backend system 170, etc.—defined by the common object model. For instance a plurality of plugins for reading data may exist with a particular one of the plurality installed with the execution system 100 for use in reading the backend system 170. For example, different reading plugins may be used with different backend systems or with different configurations of a backend system 170. The common controller object 130 may therefore translate a standardized command 120 to a standardized plugin command 140 which uses logic specific to a particular role that a plugin may fulfill and execute the standardized plugin command 140 according to whichever plugin, such as plugin 150-1, is installed for that role. It will be appreciated that other known techniques for translating incoming commands to outgoing plugin commands may be used.

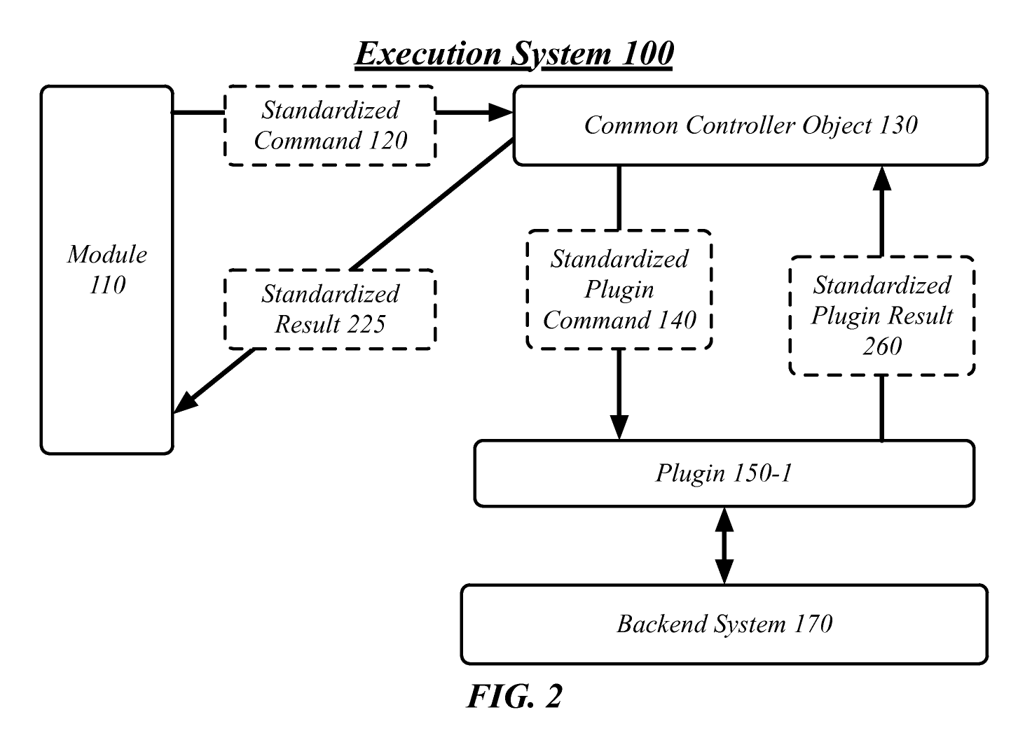

FIG. 2 illustrates a second block diagram for the execution system 100. As shown in FIG. 2, the standardized command 120 may return a standardized result 225.

The plugins 150-a may return results after receiving and performing commands. Where data is being fetched from the backend system 170 or being determined about the backend system 170, the fetched or determined data may be returned to the initiating module 110. Alternatively or additionally, a returned result may indicate the success or failure of a requested command, such as via one or more status codes. In general, a plugin 150-1 may be operative to receive a standardized plugin command 140 from the common controller object 130, to perform the standardized plugin command 140 using the backend system 170, and to return to the common controller object 130 a standardized plugin result 260 representing the result of performing the standardized plugin command 140 using the backend system 170.

Data fetched from the backend system 170 may include data stored in the backend system 170, data calculated by the backend system 170, or any other data related to the primary purpose of the backend system 170. Data determined about the backend system 170 may include the health status of the backend system 170, various properties of the backend system 170, or other data that relates to the ability of the backend system 170 to perform is task or a current status of the backend system 170.

As such, the common controller object 130 may be operative to receive the standardized command 120 and to return in response to the standardized command 120 a standardized result 225. Receiving a command and returning a result may comprise a call to a function that is part of the common controller object 130 such as through a class for the common controller object 130 and a return result from that function call. Receiving a command and returning a result may comprise the reception of a request over a network and a transmission of a response over the network. Receiving a command and returning a result may comprise any technique for communicating commands to and receiving results from an object such as common controller object 130.

The common controller object 130 may be operative to receive a standardized command 120 from a module 110, to generate a standardized plugin command 140 based on the standardized command 120, to identify a plugin 150-1 of a plurality of plugins 150-a to handle the standardized command 120, to submit the standardized plugin command 140 to a plugin 150-1, to receive a standardized plugin result 260 from the plugin 150-1, to transform the standardized plugin result 260 to a standardized result 225, and to return the standardized result 225 to the module 110 as a response to the standardized command 120. In some embodiments, particularly for simple commands, the standardized plugin result 260 may be used directly as the standardized result 225.

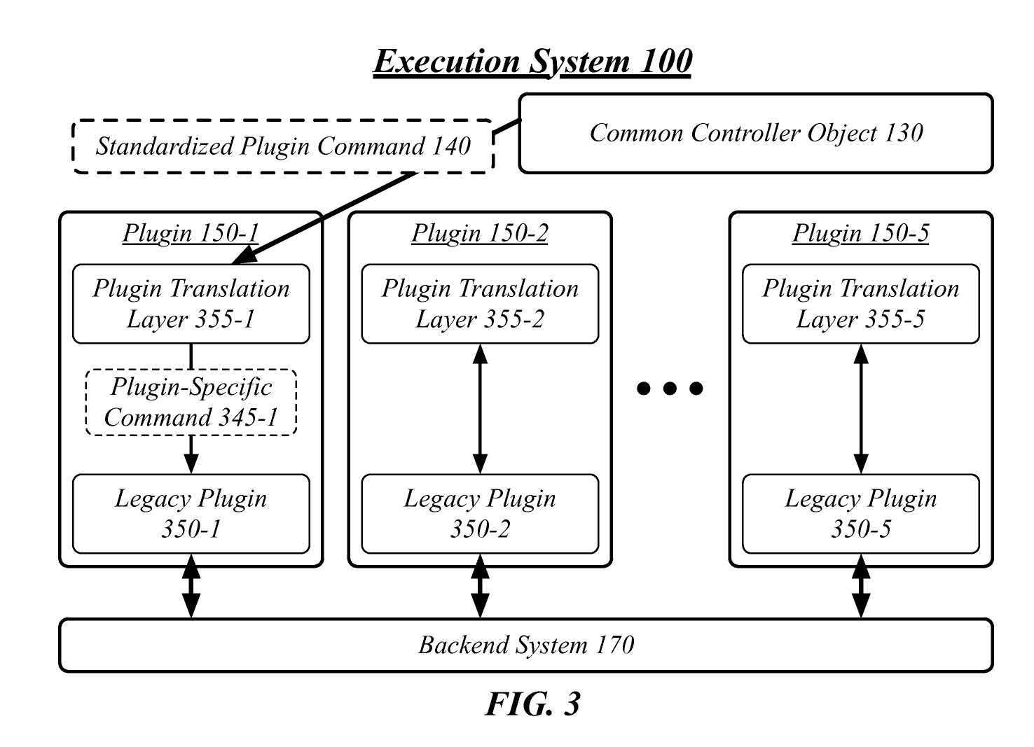

FIG. 3 illustrates a third block diagram for the execution system 100. As shown in FIG. 3, the plugins 150-a may comprise legacy plugins 350-b.

In some embodiments, the plugins 150-a may comprise plugins written to conform to the common object model, wherein the plugins 150-a use the common object model as their internal data representation. In some embodiments, however, the plugins 150-a may comprise legacy plugins 350-c using different object models. In some cases, all or some of the legacy plugins 350-c may use a shared object model that is distinct from the common object model. In some cases, some or all of the legacy plugins 350-c may each use a legacy object model specific to each legacy plugin, such that the legacy object model for a legacy plugin 350-1 is specific to legacy plugin 350-1 and is not used by any other plugin. In some embodiments, some of the plugins 150-a may comprise legacy plugins while others are native plugins and use the common object model as their internal data representation.

Plugins 150-a which comprise a legacy plugin 350-c may use a plugin translation layer 355-b to translate between the common object model and their specific legacy object model. A plugin translation layer 355-1 may receive a standardized plugin command 140, the standardized plugin command 140 conforming to the common object model. The plugin translation layer 355-1 for the plugin 150-1 may translate the standardized plugin command 140 to a plugin-specific command 345-1. The plugin-specific command 345-1 may correspond to the legacy object model of the legacy plugin 350-1 which may be specific to the legacy plugin 350-1 or shared with other plugins while being distinct from the common object model. The plugin translation layer 355-1 may submit the plugin-specific command 345-1 to the legacy plugin 350-1. The legacy plugin 350-1 may then execute the plugin-specific command 345-1 using the backend system 170.

Translating a standardized plugin command 140 to a plugin-specific command 245-1 may comprise reformatting one or more pieces of data contained within the standardized plugin command 140, such as one or more pieces of data submitted as parameters of the standardized plugin command 140. Translating a standardized plugin command 140 to a plugin-specific command 245-1 may comprise combining together data, instantiating new objects in the legacy object model of the legacy plugin 250-1, adding additional parameters, or any other known technique for translating a command from a first object model to a second object model.

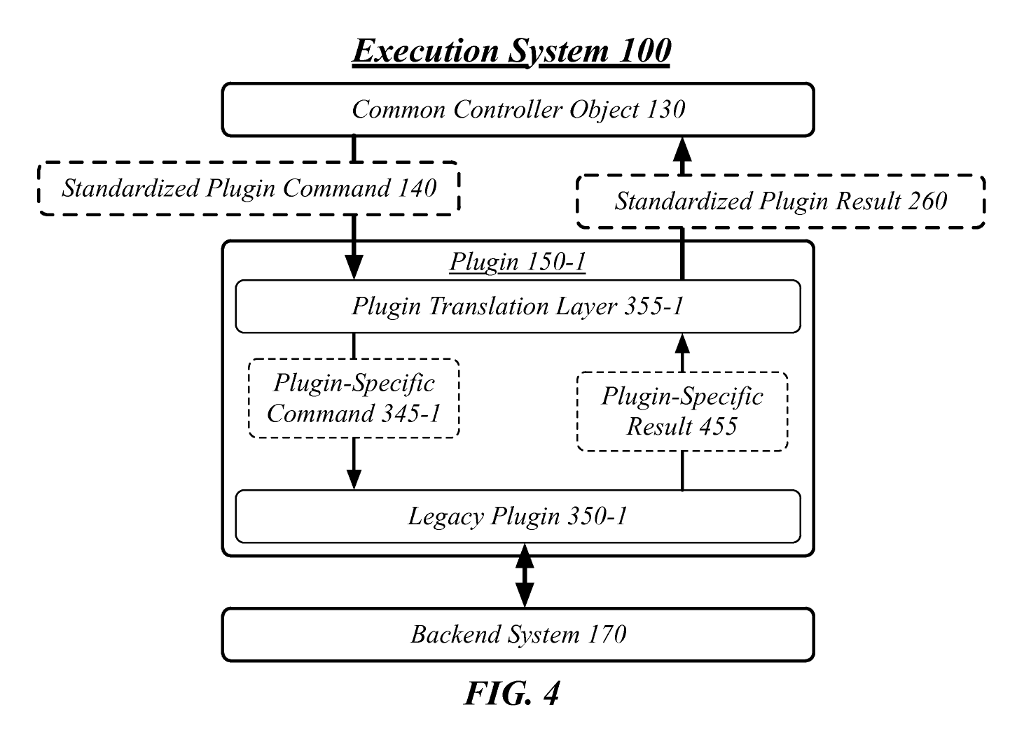

FIG. 4 illustrates a fourth block diagram for the execution system 100. As shown in FIG. 4, the legacy plugin 250-1 may return a plugin-specific result 455.

The legacy plugin 250-1 may return a plugin-specific result 455 to the plugin translation layer 255-1, the plugin-specific result 455 conforming to the legacy object model for the legacy plugin 250-1. The plugin translation layer 255-1 may receive the plugin-specific result 455, translate the plugin-specific result 455 to a standardized plugin result 260, and return the standardized plugin result 260 to the common controller object 130.

Translating a plugin-specific result 455 to a standardized plugin result 260 may comprise reformatting one or more pieces of data contained within the plugin-specific result 455, such as one or more pieces of data retrieved from the backend system 170, calculated by the backend system 170, or determined about the backend system 170. Translating a plugin-specific result 455 to a standardized plugin result 260 may comprise combining together data, instantiating new objects in the common object model, adding additional data, or any other known technique for translating a result from a first object model to a second object model.

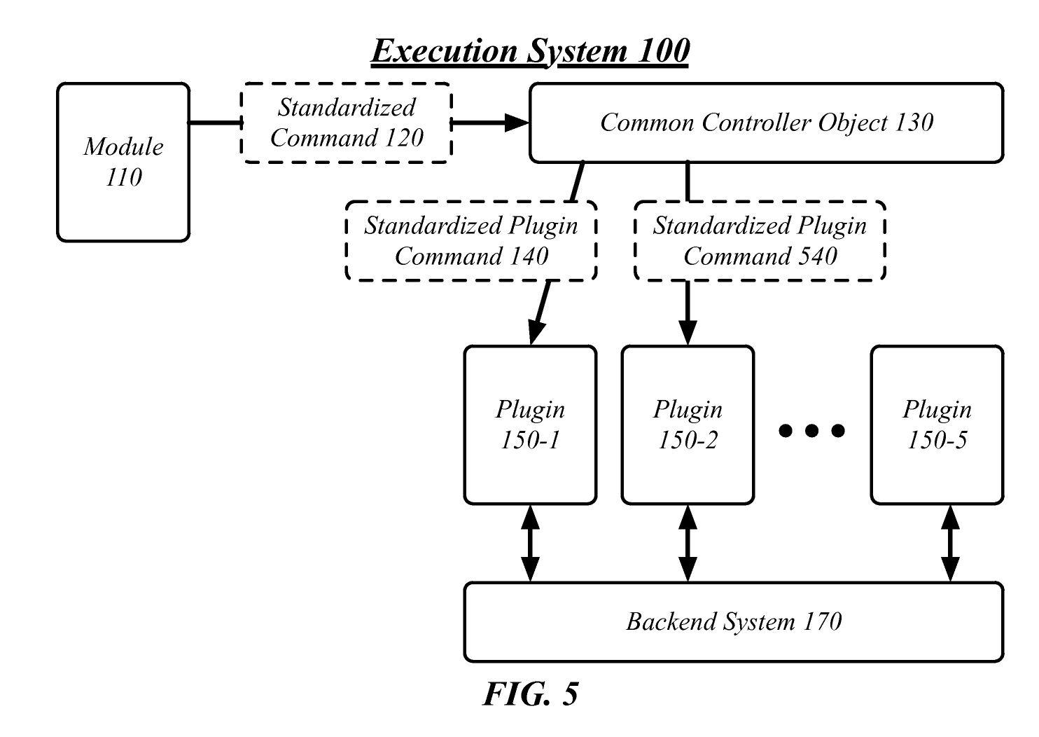

FIG. 5 illustrates a fifth block diagram for the execution system 100. As shown in FIG. 5, multiple plugins of the plurality of plugins 150-a may be used in executing standardized command 120.

In some cases, a standardized command 120 may encapsulate within its request a sufficient scope of activity as to correspond to the roles or domains of multiple plugins of the plurality of plugins 150-a. For example, different plugins may be used for determining different aspects of the health of a system: the current load on various servers which may comprise the backend system 170, the number of jobs waiting in a job queue of the backend system 170, etc. In some embodiments, a single standardized command 120 might request a holistic health status for the backend system 170 as a whole, where the holistic health status combines together multiple health statuses determined by multiple plugins into a single status representing the overall health of the backend system 170.

As such, the common controller object 130 may receive a standardized command 120 and generate both a first standardized plugin command 140 and a second standardized plugin command 540 based on the standardized command 120, wherein both the first standardized plugin command 140 and the second standardized plugin command 540 conform to the common object model. A first plugin 150-1 may receive the first standardized plugin command 140 and execute the first standardized plugin command 140. A second plugin 150-2 may receive the second standardized plugin command 540 and execute the second standardized plugin command 540.

In some embodiments, both the first plugin 150-1 and second plugin 150-2 may comprise legacy plugins 350-1 and 350-2 respectively and may process the standardized plugin commands 140 and 540 using plugin translation layers 355-1 and 355-2 respectively. In some embodiments, the first plugin 150-1 may comprise a legacy plugin 250-1 and process the first standardized plugin command 140 using a first plugin translation layer 355-1 while the second plugin 150-2 comprises a native plugin whose internal object model is the common object model. In some embodiments, both the first and second plugins 150-1 and 150-2 may comprise native plugins and may process their respective standardized plugin commands 140 and 540 using the common object model as their internal object model.

In general, where multiple plugins are used for the processing of a standardized command 120 any combination of native plugins and legacy plugins may be used. As the common controller object 130 communicates with the plugins 150-a whether or not they are legacy plugins or native plugins, the common controller object 130 may be agnostic as to the internal object model of the plugins 150-a used to process a standardized command 120. This may serve to ease the development of the common controller object 130. In particular, the development of the common controller object 130 may be focused on supporting the common layer API using a plurality of plugins 150-a using the common object model, with its logic dedicated to determining relevant plugins, demultiplexing commands, and multiplexing results without concern for the internal object models of the plugins 150-a.

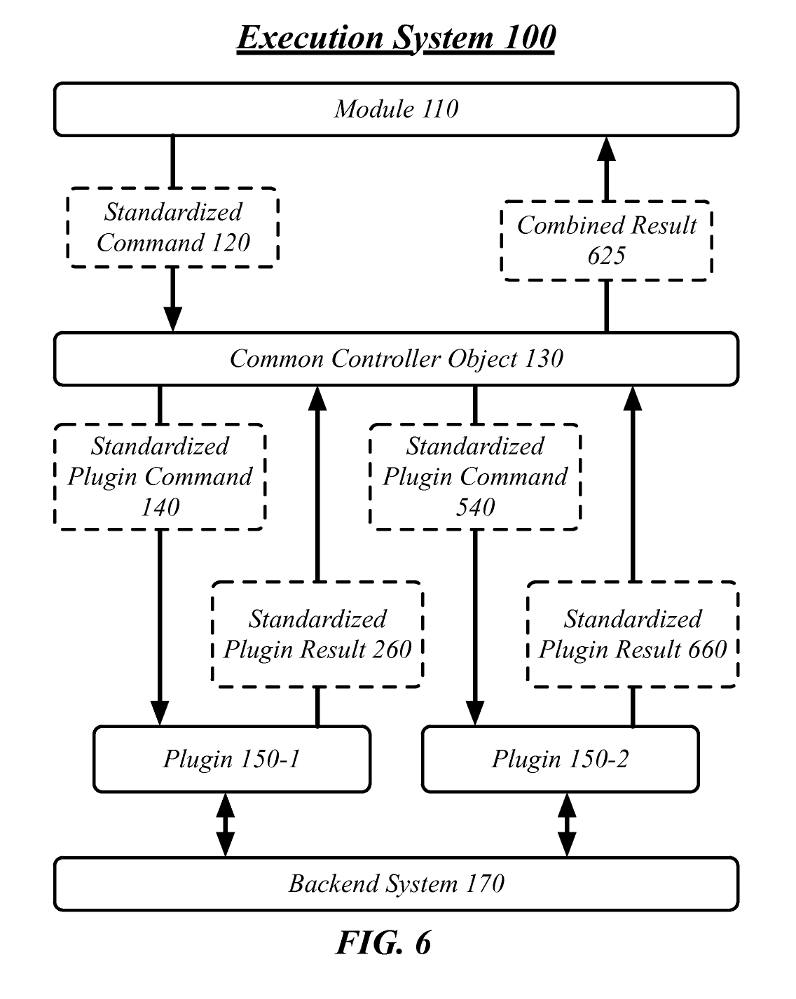

FIG. 6 illustrates a sixth block diagram for the execution system 100. As shown in FIG. 6, the standardized command 120 may return a combined result 625.

In some embodiments, the standardized command 120 may return a standardized result 225 precisely or approximately corresponding to a single standardized plugin result 260 returned by a single plugin 150-1. In some cases, this may be because the standardized command 120 falls entirely within the domain of a single plugin 150-1 and can be processed entirely by the single plugin 150-1.

However, in some cases, the response to a standardized command 120 may combine together data received from multiple plugins. The common controller object 130 may receive a standardized command 120 and generate both a first standardized plugin command 140 and a second standardized plugin command 540 based on the standardized command 120. The first plugin 150-1 may receive the first standardized plugin command 140, execute the first standardized plugin command 140 using the backend system 170, and return a first standardized plugin result 260. The second plugin 150-2 may receive the second standardized plugin command 540, execute the second standardized plugin command 540 using the backend system 170, and return a second standardized plugin result 660. The common controller object 130 may be operative to combine the first standardized plugin result 260 and the second standardized plugin command 540 to generate a combined result 625 and to return the combined result 625 to the module 110.

For example, where a single standardized command 120 requests a holistic health status for the backend system 170 as a whole, the standardized plugin result 260 might comprise a first health status parameter, the standardized plugin result 660 may comprise a second health status parameter, with the common controller object 130 operative to combine the health status parameters into a holistic health status return as the combined result 625 to the module 110.

In some embodiments, the module 110 may comprise a user interface component operative to receive a user command from a user, to determine the standardized command 120 based on the user command, to submitted the standardized command 120 to the common controller object 130, to receive a standardized result 225 or combined result 625 from the common controller object 130, and to display the standardized result 225 or combined result 625 for the user. In some cases, a user interface component may be part of a user interface application for interfacing with the backend system 170, such as a front-end application for the execution system 100 as a whole. The user interface application may consume the common controller object 130 for use in interfacing with the backend system 170, using procedure calls and receiving the result of procedure calls defined as part of a common controller class for the common controller object 130.

With various plugins 150-a that are separate plugins handling a particular domain of interaction with the backend system 170 the providing of a consistent user interface may be difficult for a developer. For instance if multiple plugins are used to retrieve different types of health status for the backend system 170, it may be difficult to provide a consistent user interface across the multiple plugins. Some implementations, particularly those that do not use the common controller object 130, may use a separate window, sub-window, pane, panel, frame, or other distinct user interface element for each plugin wherein a distinct user interface element is used for each plugin to submit commands to the plugin and receive responses to the submitted commands. In these implementations the commands and responses may conform to the individual object models of the plugins with no consistency between them.

In contrast, implementations, such as for user interface components or user interface applications, which use the common controller object 130 may provide a unified input interface and unified display. A unified input interface may correspond to where a single control—such as a button, text-entry box, menu item, or any other user interface (UI) control—may spawn a standardized command 120 that is demultiplexed to multiple plugins. A unified display may correspond to where a single display element—such as a text string, graph, image, icon, or any other UI display element—may have been generated by results multiplexed, or otherwise combined together, from multiple plugins. In general, a user interface component or user interface application may allow for the initiation of commands and display of data according to the common object model which operates in a uniform API layer across all of the plugins 150-a for the execution system 100.

In another example, a module 110 might request that a particular file managed by the backend system 170 be duplicated. In some embodiments, this may be implemented with a first plugin 150-1 to read the file from the backend system 170 and a second plugin 150-2 to write a copy of the file to the backend system 170. The common controller object may therefore generate the first standardized plugin command 140 based on the standardized command 120, the first standardized plugin command 140 comprising a read operation, execute the first standardized plugin command 140 using the first plugin 150-1, and receive the first standardized plugin result 260 comprising the file. The common controller object may then generate the second standardized plugin command 540 with the retrieved file as an input parameter for the second standardized plugin command 540 and submitted to the plugin 150-2 for the execution of the second standardized plugin command 540. The second plugin 150-2 may execute the second standardized plugin command 540 based on the first standardized plugin result 260 submitted as a parameter. The second plugin 150-2 may return a second standardized plugin result 660 to the common controller object 130. The second plugin result 150-2—for example, a result indicating a successful write operation—may then be returned by the common controller object 130 to the module 110 to indicate the result of the chained command. In some embodiments, the first standardized plugin result 260 and the second standardized plugin result 660 may still be combined to determine a combined result 625, such as where the combined result 625 encompasses the success (and/or failure) of the read and write operations.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

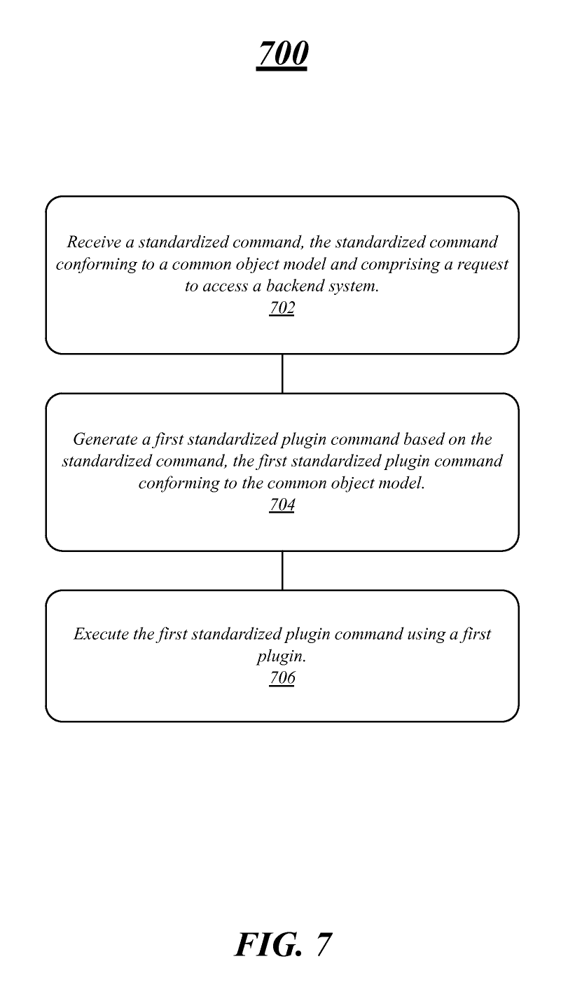

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may receive a standardized command 120, the standardized command 120 conforming to a common object model and comprising a request to access a backend system 170 at block 702. For example, the standardized command 120 may be a command for read access, write access, job submission, task processing, discovery, health monitoring, capacity management, provisioning, cloning, backing-up, restoration, or disaster recovery.

The logic flow 700 may generate a first standardized plugin command 140 based on the standardized command 120, the first standardized plugin command 140 conforming to the common object model at block 704. For example, the first standardized plugin command 140 may comprise a command for read access, write access, job submission, task processing, discovery, health monitoring, capacity management, provisioning, cloning, backing-up, restoration, or disaster recovery expressed as a command to a plugin according to a common plugin API.

In some cases, the logic flow 700 may generate a second standardized plugin command 540 based on the standardized command 120, the second standardized plugin command 540 conforming to a common object model.

The logic flow 700 may execute the first standardized plugin command 140 using a first plugin 150-1 at block 706. Executing a first standardized plugin command 140 using a first plugin 150-1 may comprise submitting the first standardized plugin command 140 to the first plugin 150-1 and receiving a first standardized plugin result 260 from the first plugin 150-1.

Where the logic flow 700 generates a second standardized plugin command 540, the second standardized plugin command 540 may be executed using a second plugin 150-2. As with the first plugin 150-1, executing the second standardized plugin command 540 using a second plugin 150-2 may comprise submitting the second standardized plugin command 540 to the second plugin 150-2 and receiving a second standardized plugin result 660 from the second plugin 150-2. The first standardized plugin result 260 may be used with the standardized command 120 to generate the second standardized plugin command 540. The first standardized plugin result 260 may be combined with the second standardized plugin result 660 to generate a combined result 625 representing a total response to the standardized command 120.

In some embodiments, the first plugin 150-1 may comprise a first legacy plugin 350-1 wrapped with a first plugin translation layer 355-1. The first plugin translation layer 355-1 may perform a sequence of operations to execute the first standardized plugin command 140, comprising: receiving the first standardized plugin command 140, translating the first standardized plugin command 140 to a first plugin-specific command 345-1 specific to a first legacy plugin 350-1, submitting the first plugin-specific command 345-1 to the first legacy plugin 350-1, receiving a first plugin-specific result 455 from the first legacy plugin 350-1, translating the first plugin-specific result 455 to a first standardized plugin result 260, and returning the first standardized plugin result 260.

The embodiments are not limited to this example.

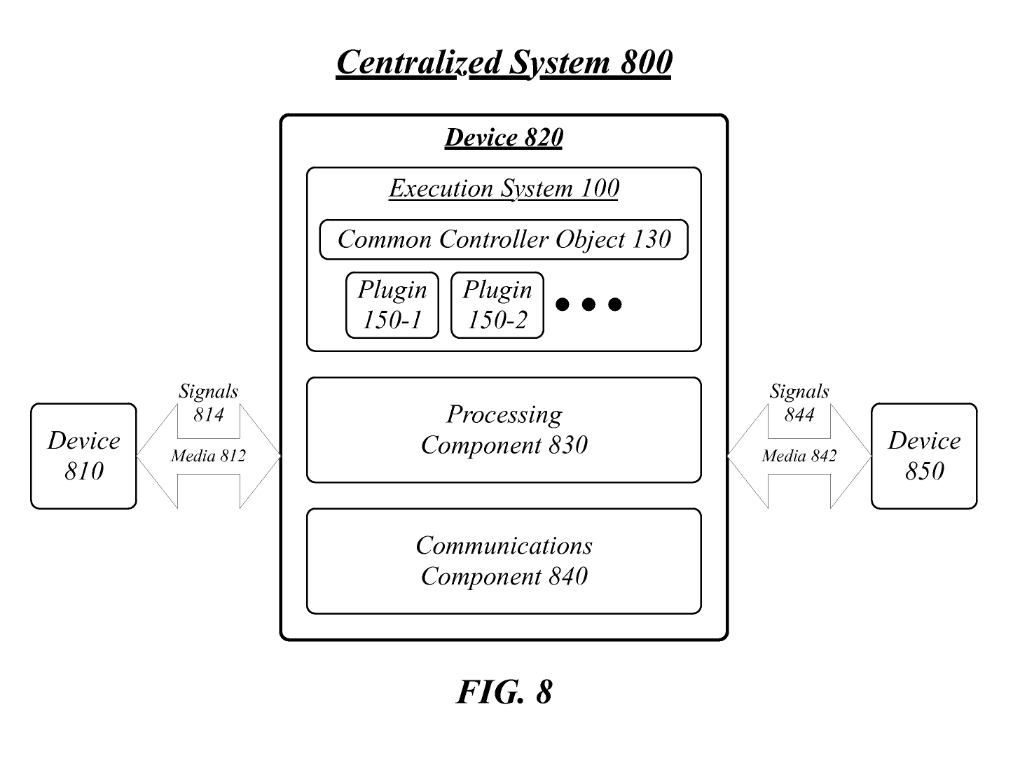

FIG. 8 illustrates a block diagram of a centralized system 800. The centralized system 800 may implement some or all of the structure and/or operations for the execution system 100 in a single computing entity, such as entirely within a single device 820.

The device 820 may comprise any electronic device capable of receiving, processing, and sending information for the execution system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the execution system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the execution system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation.

Device 810 may correspond to a first-party device being used as to provide a user interface to a user of the execution system 100. For example, device 810 may be located as part of the same network as the execution system 100 and maintained by the same operator as the execution system 100. The signals 814 sent over media 812 may correspond to signals sent over a local network for the submission of commands and return of results. The device 810 may comprise a user interface application that has consumed the common controller object 130.

Device 850 may correspond to a third-party device being used to provide access to the execution system 100 by an external party. For example, device 850 may be located as part of a separate network as the execution system 100 and be maintained by a different operator as the execution system 100. The signals 844 sent over media 842 may correspond to signals sent over a wide-area network such as the Internet for the submission of commands and the return of results. The device 850 may comprise a user interface application that communicates with the common controller object 130 over the wide-area network. The device 850 may comprise a web client that communicates with the common controller object 130 using a web-based protocol such as the Hypertext Transport Protocol (HTTP), Hypertext Transport Protocol Secure (HTTPS), or any other web-based protocol. Alternatively, the device 850 may comprise a user interface application or web client that has consumed the common controller object 130, with the common controller object 130 communicating with the remainder of the execution system 100 over the wide-area network using signals 844 sent over media 842.

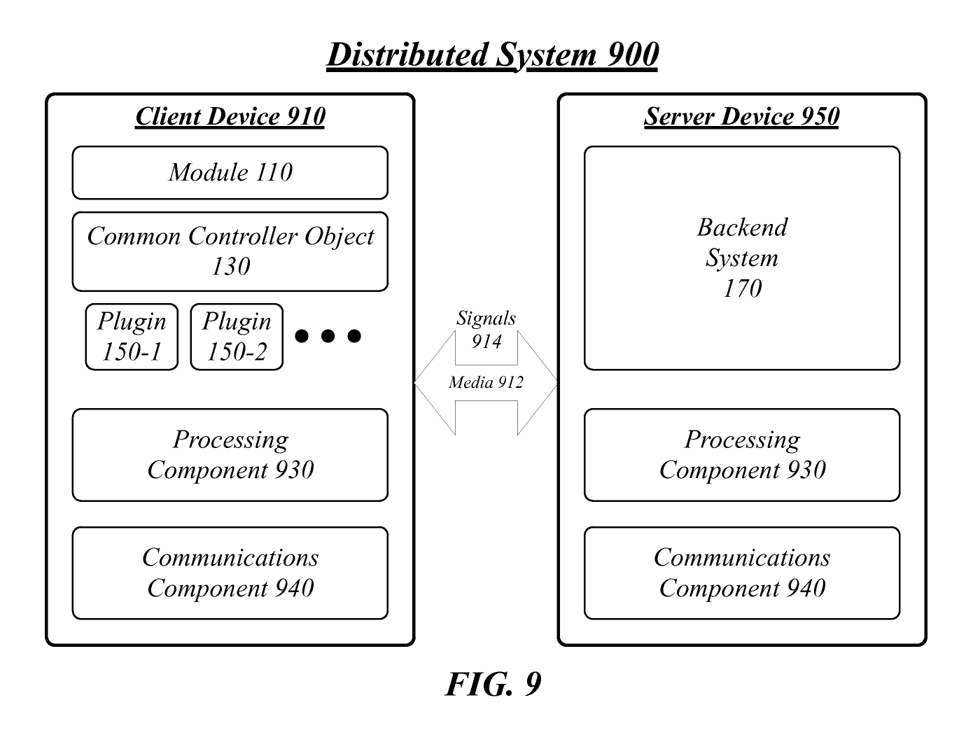

FIG. 9 illustrates a block diagram of a distributed system 900. The distributed system 900 may distribute portions of the structure and/or operations for the execution system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the client device 820 as described with reference to FIG. 8. For instance, the client system 910 and the server system 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement the module 110, the common controller object 130, and the plugins 150-a. The server device 950 may comprise or employ one or more server programs that operate to perform various methodologies in accordance with the described embodiments. In one embodiment, for example, the server device 950 may implement the backend system 170. The signals 914 sent over media 912 may comprise the submission of commands from the plugins 150-a to the backend system 170 on behalf of the common controller object 130 and the return of responses to those commands by the backend system 170.

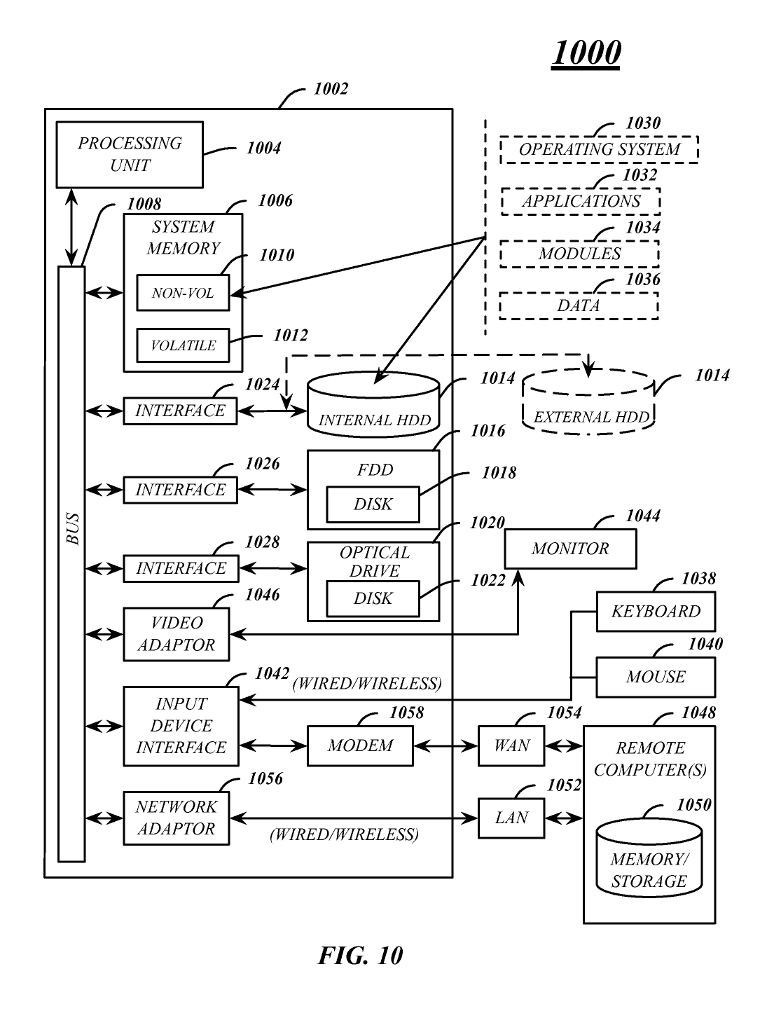

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD®, Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the execution system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.10 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.10x (a, b, g, n, etc.) to provide secure, reliable, fast wireless connectivity. A Wi-Fi network can be used to connect computers to each other, to the Internet, and to wire networks (which use IEEE 802.3-related media and functions).

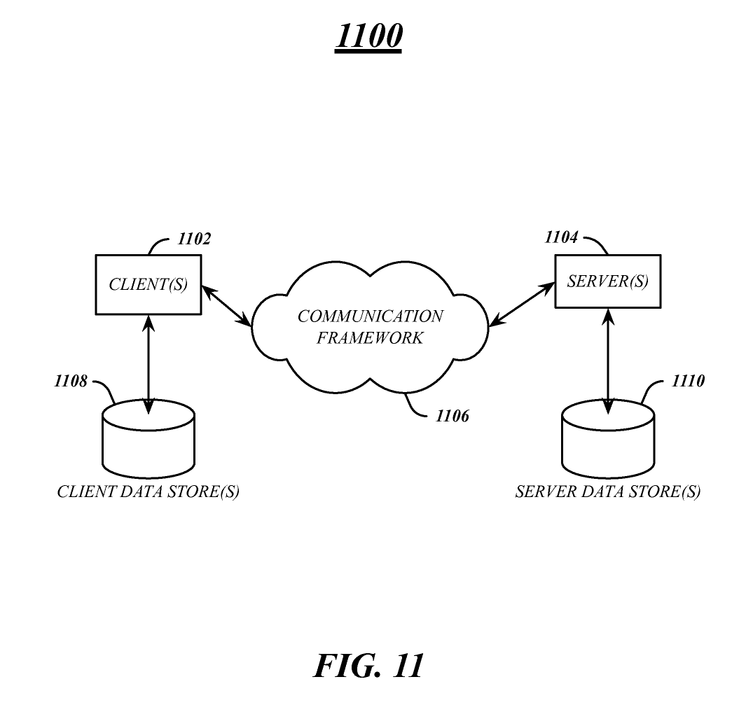

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server device 950. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
a processor circuit on a device;
a common controller object operative on the processor circuit to receive a standardized command from a module and to generate a first standardized plugin command based on the standardized command, the standardized command and first standardized plugin command conforming to a common object model;
a first plugin operative to execute the first standardized plugin command.

2. The apparatus of claim 1, the standardized command a request to access a backend system by the module, the first plugin operative to perform the first standardized plugin command using the backend system.

3. The apparatus of claim 1, the first plugin comprising:
a first plugin translation layer operative to receive the first standardized plugin command, to translate the first standardized plugin command to a first plugin-specific command specific to a first legacy plugin, and to submit the first plugin-specific command to the first legacy plugin, the first legacy plugin using a first legacy object model distinct from the common object model; and
the first legacy plugin operative to execute the first plugin-specific command.

4. The apparatus of claim 3, comprising:
the first legacy plugin operative to return a first plugin-specific result;
the first plugin translation layer operative to translate the first plugin-specific result to a first standardized result and to return the first standardized result to the common controller object, the first standardized result conforming to the common object model; and
the common controller object operative to return the first standardized result to the module.

5. The apparatus of claim 1, comprising:
the common controller object operative to generate the first standardized plugin command and a second standardized plugin command based on the standardized command, the second standardized plugin command conforming to a common object model; and
a second plugin operative to execute the second standardized plugin command.

6. The apparatus of claim 5, comprising:
the first plugin operative to return a first plugin result;
the second plugin operative to return a second plugin result;
the common controller object operative to combine the first plugin result and the second plugin result to generate a combined result and to return the combined result to the module.

7. The apparatus of claim 6, the module comprising a user interface component operative to receive a user command from a user, to determine the standardized command based on the user command, to submit the standardized command to the common controller object, to receive the combined result, and to display the combined result for the user on a unified display, the user command received from the user via the unified display.

8. The apparatus of claim 1, comprising:
the common controller object operative to generate the first standardized plugin command based on the standardized command, to generate a second standardized plugin command based on the standardized command and a first plugin result, and to return a second plugin result to the module, the second standardized plugin command conforming to a common object model;
the first plugin operative to return a first plugin result; and
a second plugin operative to execute the second standardized plugin command and return the second plugin result.

9. A computer-implemented method, comprising:
receiving a standardized command, the standardized command conforming to a common object model;
generating a first standardized plugin command based on the standardized command, the first standardized plugin command conforming to the common object model; and
executing the first standardized plugin command using a first plugin.

10. The method of claim 9, the standardized command a request to access a backend system, the first plugin performing the first standardized plugin command using the backend system.

11. The method of claim 9, executing the first standardized plugin command using the first plugin comprising:
receiving the first standardized plugin command;
translating the first standardized plugin command to a first plugin-specific command specific to a first legacy plugin; and
submitting the first plugin-specific command to the first legacy plugin, the first legacy plugin using a first legacy object model distinct from the common object model.

12. The method of claim 11, executing the first standardized plugin command using the first plugin further comprising:
receiving a first plugin-specific result from the first legacy plugin;
translating the first plugin-specific result to a first standardized result;
returning the first standardized result.

13. The method of claim 9, comprising:
generating a second standardized plugin command based on the standardized command, the second standardized plugin command conforming to a common object model; and
executing the second standardized plugin command using a second plugin.

14. The method of claim 13, comprising:
receiving a first plugin result from the first plugin;
receiving a second plugin result from the second plugin;
combining the first plugin result and the second plugin result to generate a combined result; and
returning the combined result.

15. The method of claim 14, comprising:
receiving a user command from a user via a unified display;
determining the standardized command based on the user command; and
displaying the combined result for the user on the unified display.

16. At least one computer-readable storage medium comprising instructions that, when executed, cause a system to:
receive a standardized command, the standardized command conforming to a common object model and comprising a request to access a backend system;
generate a first standardized plugin command based on the standardized command, the first standardized plugin command conforming to the common object model; and
execute the first standardized plugin command using a first plugin.

17. The computer-readable storage medium of claim 16 comprising further instructions that, when executed, cause a system to:
receive the first standardized plugin command;
translate the first standardized plugin command to a first plugin-specific command specific to a first legacy plugin;
submit the first plugin-specific command to the first legacy plugin, the first legacy plugin using a first legacy object model distinct from the common object model;
receive a first plugin-specific result from the first legacy plugin;
translate the first plugin-specific result to a first standardized result;
return the first standardized result.

18. The computer-readable storage medium of claim 16 comprising further instructions that, when executed, cause a system to:
generate a second standardized plugin command based on the standardized command, the second standardized plugin command conforming to a common object model; and
execute the second standardized plugin command using a second plugin.

19. The computer-readable storage medium of claim 18 comprising further instructions that, when executed, cause a system to:
receive a first plugin result from the first plugin;
receive a second plugin result from the second plugin;
combine the first plugin result and the second plugin result to generate a combined result; and
return the combined result.

20. The computer-readable storage medium of claim 20 comprising further instructions that, when executed, cause a system to:
receive a user command from a user via a unified display;
determine the standardized command based on the user command; and
display the combined result for the user on the unified display.
